(19) United States
(12) Patent Application Publication
(10) Pub. No.: US 2024/0054440 A1
(43) Pub. Date: Feb. 15, 2024

(54) SYSTEM OF AND METHOD FOR LOAD RECOMMENDATIONS

(71) Applicant: Crowley Government Services, Inc., Jacksonville, FL (US)

(72) Inventors: Madison Strong, Yulee, FL (US); Bhaskar Mandapaka, Toronto (CA); Neil Athavale, Jacksonville, FL (US); Shashank Panchangam, Fulshear, TX (US); Ashwani Dev, Jacksonville, FL (US); Carey Hepler, Jacksonville, FL (US); Chris Wolfl, Saint Johns, FL (US); Smijith Kunhiraman, Jacksonville, FL (US)

(21) Appl. No.: 18/447,940

(22) Filed: Aug. 10, 2023

Related U.S. Application Data
(60) Provisional application No. 63/397,182, filed on Aug. 11, 2022.

(51) Int. Cl. G06Q 10/0835; G06Q 10/0836

(52) U.S. Cl. CPC G06Q 10/0835; G06Q 10/0836

(57) ABSTRACT

Systems, methods, and computer-readable storage media for recommending loads for transport. A system can receive location coordinates for a transport vehicle, and further receive data regarding available loads which can be transported by the transport vehicle. The system can then filter the available loads based at least in part on the location coordinates. The system can also receive at least one carrier profile and at least one shipper profile. Finally, the system can execute a load recommendation algorithm using the preference filtered loads, the at least one carrier profile, and the at least one shipper profile as inputs, resulting in at least one load recommendation score for a load within the preference filtered loads.

### CROSS-REFERENCE TO RELATED APPLICATION

This application claims priority benefit from U.S. Provisional Patent Application No. 63/397,182, filed on Aug. 11, 2022, the entire content of which is incorporated herein by reference.

### BACKGROUND

### 1. Technical Field

The present disclosure relates to load recommendations, and more specifically to filtering and optimizing load recommendations based on load, carrier, and supplier profiles.

### 2. Introduction

Freight suppliers struggle to match specific loads with appropriate carriers, while freight carriers struggle to find specific loads to transport from suppliers to destinations. Sometimes these struggles are due to preferences of the suppliers or carriers. In other instances, the struggle is due to capacity, licenses/certifications, locations of the pickup or drop-off, current location of a carrier, costs, and/or load type.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, location coordinates for a transport vehicle; receiving, at the computer system, a list of available loads which can be transported by the transport vehicle; filtering, via at least one processor of the computer system, the list of available loads based at least in part on the location coordinates, resulting in filtered loads; receiving, at the computer system, at least one carrier profile and at least one shipper profile; and executing, via the at least one processor, a load recommendation algorithm using the filtered loads, the at least one carrier profile, and the at least one shipper profile as inputs, resulting in at least one load recommendation score for at least one load within the filtered loads.

A system configured to perform the concepts disclosed herein can include: at least one processor; and a non-transitory computer-readable storage medium having instructions stored which, when executed by the at least one processor, cause the at least one processor to perform operations comprising: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered loads.

A non-transitory computer-readable storage medium configured as disclosed herein can have instructions stored which, when executed by a computing device, cause the computing device to perform operations which include: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered loads.

### BRIEF DESCRIPTION OF THE DRAWINGS

FIG. 1 illustrates an example of a collaborative filtering algorithm;

FIG. 2 illustrates an example system diagram;

FIG. 3 illustrates an example of a load recommendation algorithm;

FIG. 4 illustrates an example method embodiment;

FIG. 5 illustrates an example computer system; and

FIG. 6 illustrates an alternative system diagram.

### DETAILED DESCRIPTION

Various embodiments of the disclosure are described in detail below. While specific implementations are described, this is done for illustration purposes only. Other components and configurations may be used without parting from the spirit and scope of the disclosure.

Freight carriers (“carriers”) transport a load from a source location to a destination/drop-off location. Exemplary, non-limiting means for transport can include trucking, rail, and shipping. When possible, those carriers prefer to pick-up an additional load, called a “backhaul,” for the trip back. The system and method of the disclosure provide a system for recommending loads to carriers based on qualities of the loads, preferences of the carriers and suppliers, collaborative filtering, and multi-object optimization. In some configurations, the principles disclosed herein can also be used by suppliers to identify potential carriers to assist in transporting a load. Loads, as described herein, can include any item (or more commonly, a set of items) which is to be transported by a carrier to a destination. Carriers are individuals or companies whose job it is to move loads posted by shippers to destinations (such as retail locations, distribution centers, logistic hubs, ports, or residences) (also known as suppliers).

Consider the following example. A trucking carrier spends several hours a day looking for loads to transport. The search is made more difficult because this carrier has a particular type of truck which is incompatible with many of the jobs appearing in their geographic region. Moreover, the carrier has had negative interactions with some of the suppliers in the area, meaning that in addition to difficulty finding a load with a load type they are capable of transporting, they would prefer to not work with certain suppliers. In this example, the carrier eventually finds a load, but can find no cost-efficient backhaul, and therefore returns with an unloaded truck to the home location, meaning that the return trip is completely funded by the carrier, losing money due to fuel and driver time during the empty drive home.

Using the system and method disclosed herein, the carrier can: (1) filter out loads for which they are not qualified or equipped to execute; (2) filter out suppliers based on preferences; (3) filter out remaining loads/suppliers based on collaborative filtering (e.g., previous behavior of the carrier, supplier, and/or previous instances of a similar load being transported along the same lane (source/destination); and (4) optimized for other qualities sought after by the carrier, such as cost per mile, amount of “deadhead” (traveling without a load such that the carrier is losing money due to fuel and driver costs), distance required by the load, etc. The collaborative filtering can rely on combinations between (1) the carrier and the load, (2) the load and the shipper, and/or (3) the shipper and the carrier.

Consider the following example. The system receives data regarding loads provided by suppliers looking to move their freight. This data, also called a load profile, can contain all the attributes for a particular load including, but not limited to: the total load rate, the shipper name, the shipper address, pick-up date and time, delivery date and time, pick-up location, drop-off location, equipment type, weight, total miles, age of the load, time left to bid on the load, rate per mile, and a load rating (e.g., whether a load is a good load or not).

The system also receives a shipper profile for the shipper posting the load, and a carrier profile for the carrier looking for a load to move. A shipper profile (aka a supplier profile) is created for each shipper user using the system to give insight on their way of working. Ratings and reviews by carriers that have worked with that shipper are housed in their profile for other carriers to see. If a shipper's loads require special certifications or licensure (e.g., hazardous material), that would be notated in the shipper profile along with equipment needed to transport the load. Other badges or key indicators that would attract carriers, such as being a ‘Women Friendly Shipper’ or allowing access to their bathrooms, breakrooms, etc., is notated within the shipper profile as well.

The carrier profile, like the shipper profile, is created for each carrier user to capture their preferred way of working and performance. The carrier profile tracks the preferred lanes and routes that a carrier might run, and/or preferred shippers the carrier likes to work with. Similarly, a shipper can rate the experience with a carrier out of five stars and leave reviews for other shippers to see. The carrier profile also contains operating information, such as special licensures or certifications to operate oversize or hazardous loads, as well as basic company information like a home base location, type of equipment the carrier has, and CO 2 emissions of the carrier. This carrier profile can, in some configurations, even be broken down to the driver level depending on how many drivers a carrier utilizes.

Using the load profile, shipper profile, and carrier profile, the system looks to recommend jobs to a carrier by first filtering available loads based on aspects of the load and the location of the carrier. Non-limiting data which can result in loads building filtered can include equipment type, pickup date, pickup location (which can be provided manually or via relay from a GPS (Global Positioning System) receiver), and/or deadhead distance. In some configurations, the system can also recommend carriers to a supplier. For example, the system can use a GPS (Global Positioning System) of the carrier to determine the carrier's transport is currently located in New Mexico while a given load is in Florida. The system can execute a deadhead calculation, calculating how far the carrier would move without a load, and based on that distance filter out some of the available loads. The load filter can use ad hoc inputs provided by the user, or use system defaults if no inputs are provided. For example, if a user wants loads that weigh less than 15 k lbs (6803.88 kg), this can be one possible option/ad hoc input which the user can select. The algorithm can take such ad hoc inputs into account when filtering available loads.

The remaining, filtered loads can then be further filtered based on the carrier profile and the supplier profile, where the preferences of the carrier and the supplier further eliminate some of the remaining filtered loads. For example, if the carrier prefers not to work with a given supplier, loads from that supplier can be filtered out of the remaining available loads. Likewise, if a supplier prefers not to work with a given carrier, loads from that supplier can be filtered out when that given carrier is looking for available loads. If the capabilities of the carrier, per their carrier profile, do not match up with the desired capabilities the supplier has listed in their supplier profile, certain loads can also be removed from the remaining available loads. In some configurations, the carrier profile may be for a company, organization, or other entity with multiple drivers. In other configurations, the carrier profile can be broken down into different sub-profiles associated with specific drivers and/or specific regions. In yet other configurations, the carrier profile can be for the company/organization/entity as a whole, and the user of the system can select a sub-profile of one or more individual drivers if desired.

The system can then execute a load recommendation algorithm. The load recommendation algorithm receives the results of the load filtering and outputs load recommendations for the user. In some configurations, the load recommendation algorithm can have, for example, additional content filtering based on non-load specific aspects of the carriers or shippers. The load recommendation algorithm can include collaborative filtering, where a collaborative filtering model tracks each user's behavior and compares it to similar behaviors by other users. In the case that a user has no history with a particular event (e.g., a particular load type, a particular lane (pick-up/drop-off/route), particular supplier, etc.), collaborative filtering refers to the behavior of similar users that do have history of that event, identifies a dominant trend among those previous instances of the event, and uses the dominant trend to make a recommendation for that user. For example, a carrier that normally operates with one type of equipment may add a new vehicle with a different kind of trailer. With this new trailer comes a new category of loads that they can take on. Because the carrier has no previous history of these types of loads, other carriers with similar preferences and equipment types will be used by the collaborative filtering model to make a recommendation based on the trends associated with those other carriers.

The load recommendation algorithm can also contain a multi-object optimization algorithm. The multi-object optimization algorithm can consider several decisions or trade-offs between conflicting objectives. For example, carriers or other users can identify objectives such as minimizing the deadhead distance a carrier must travel to a load, maximizing the price per mile when traveling with a load or without a load minimizing the distance to deliver a load, and maximizing the overall earnings for the carrier per load. The multi-object optimization algorithm can balance those objectives. For example, the carrier may indicate that their top priority is to minimize deadhead distance and maximize price per mile when traveling with a load. Using these priorities, the multi-object optimization can score the remaining potential loads, such that the highest scoring potential load is the load which best matches the priorities provided by the carrier.

In some cases, the content filtering, the collaborative filtering, and the multi-object optimization can occur sequentially. For example, the content filtering can occur first, then the collaborative filtering, and finally the multi-object optimization. In other cases, one or more aspects of the load recommendation algorithm can occur in parallel. For example, the content filtering, the collaborative filtering, and the multi-object optimization can all occur in parallel, while in another example the content filtering can occur first, with the collaborative filtering and the multi-object optimization occurring after the content filtering but in parallel. Other combinations can likewise occur.

The result of the load recommendation algorithm is a ranked list of load recommendations, with the highest ranking load recommendation being the load which passed the various filters. Systems configured as disclosed herein allow for real-time matching of shippers, carriers, and loads. When a shipper places a load on a load board to get picked up by a carrier, there are time limits to how long that load is available. A load board can, for example, be a list maintained on an electric network, where shippers can post loads they wish to have transported, with the idea being that carriers can search for loads they wish to transport. Data which can be contained within a load board post can include the pick-up/drop-off locations, delivery window, pick-up time, load types, weight, and/or other descriptions of the load materials. Systems configured as disclosed herein provide a way to match a carrier to a shipper and the shipper's loads in the time that a load is available on the load board. Once a load is posted, the load profile is created for that load. Then, when a carrier searches in a particular region, the carrier profiles, load profiles, and supplier profiles described above are fed through the system, with the eventual output being loads with the top scores for that carrier are presented to the user as the resulting recommended loads. Preferably, these recommended loads are presented according to ranking based on scores from the multi-object optimization. In some configurations, the content filtering and/or collaborative filtering can (rather than removing available loads), generate scores which can be combined with the multi-object optimization score to form the final recommendation score.

The disclosure now turns to the specific examples illustrated in the figures.

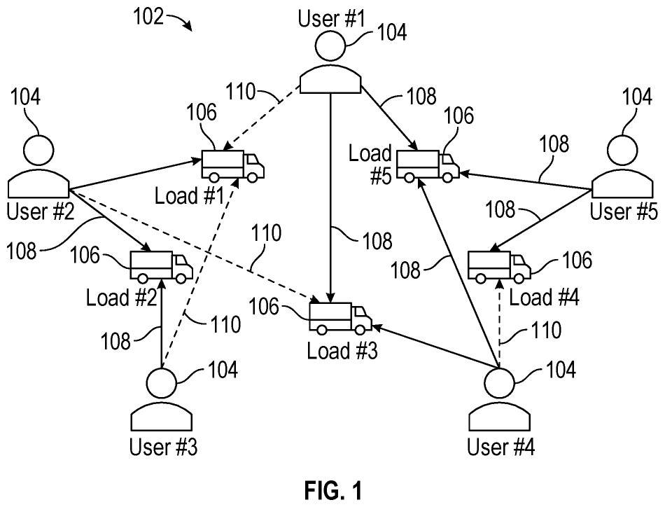

FIG. 1 illustrates an example 102 of collaborative filtering. The illustrated example shows carriers 104 and loads 106. As illustrated, the carriers 104 (e.g., User #1, User #2) each identify different loads 106 (e.g., Load #1, Load #2) which they may like or dislike, as illustrated by the solid and dashed arrows (the solid arrows 108 indicating the loads they like, while the dashed arrows 110 indicate loads they dislike). In some configurations, these likes 108 and dislikes 110 indicate potential jobs which the carriers 104 could take, where the carriers 104 are saying “I want this type of load, I don't want that type of load”; in other configurations, the likes 108 and dislikes 110 can be indicative of previous experiences of the carrier 104 with different types of loads. For example, the like 108 could be a carrier 104 leaving a good review for the load 108 they worked with and a dislike 110 could be them leaving a bad review. The likes 108 and dislikes 110 can be used to create carrier profiles for the users 104.

Preferably, the system uses three different types of collaborative filtering: carriers 104 and loads 106 (as illustrated); shippers and loads; and shippers and carriers. The same principles of the carrier 104 and load 106 example 102 of collaborative filtering can be applied to the collaborative filtering between shippers and loads and the collaborative filtering between shippers and carriers. For example, collaborative filtering between shippers and loads can be based on similarities and dissimilarities, with the shipper indicating (likes/dislikes) what types of loads they prefer to provide. Collaborative filtering between the shippers and carriers could a like in the form of the carrier leaving a good review for the shipper they worked with and a dislike would be them leaving a bad review (reviews can be based on characteristics such as women friendly shippers, access to facilities, timeliness in unloading the truck, etc.). In some configurations, the shippers can also like/dislike/leave reviews for the carriers.

The likes 108 and dislikes 110 can be a binary, thumbs up/down approach. Alternatively, the likes 108 and dislikes 110 can be more specific. For example, in some configurations a carrier 104 can identify that they liked the locations associated with pick-up/drop-off, but didn't like the supplier of a particular load. Likewise, the carrier 104 may be able to identify that they liked (or disliked) the type of load, but disliked the particular lane (pick-up location, drop-off location, and route between pick-up and drop-off) required for the job. In other words, there can be both likes 108 and dislikes 110 associated with certain aspects of a load 106. This same principle applies to likes 108 and dislikes 110 between suppliers and loads for the supplier-load collaborative filter, and the supplier-carrier collaborative filter—there may be aspects of a particular relationship which are likes 108, and aspects which are dislikes 110.

Moreover, in some configurations the users 104 can be suppliers, where the suppliers can leave reviews of how carriers responded to particular loads 106. In such configurations, the user again provides likes 108 and dislikes 110, which may be broad indications of like/dislike, or more nuanced details about what aspects of a particular load the user 104 likes or dislikes.

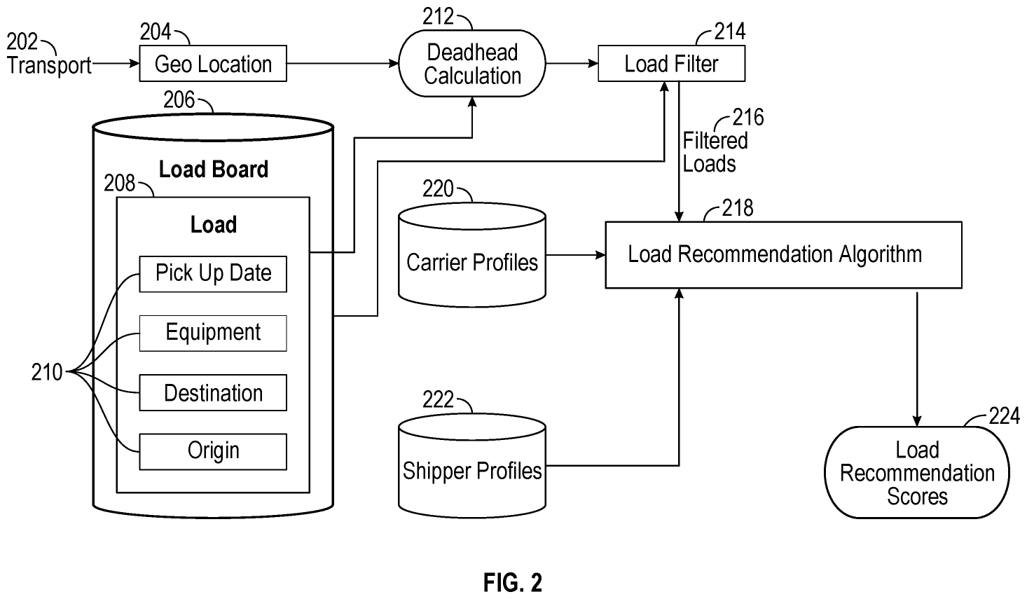

FIG. 2 illustrates an example system diagram. In this example, a geolocation 204 associated with a given transport 202 (such as a truck, barge, ship, train, or other vehicle) is determined using GPS (Global Positioning System) or other geospatial coordinate system. The transport 202 can, for example, belong to a carrier. Also illustrated is a load board 206, where shippers can post loads which need to be transported. Each load 208 posted to the load board 206 can contain various attributes 210 about the load 208, which the system can use to generate a “load profile.” Exemplary attributes can include a pick-up date and/or location, equipment needed, a destination/drop-off date and/or location, an origin of the load, type of material being transported (e.g., a load-type). Using the load profile for each available load 208 listed on the load board 206, and specifically the destination/origin of the load as well as the geolocation of the transport 202, the system can calculate a deadhead amount 212 that the transport 202 would have if they moved that load. These deadhead calculations 212 and/or other attributes 210 of the loads, can be used by the system to filter 214 available jobs based on attributes of the loads and the location of the transport 202.

The shippers and carriers interacting with the load board 206 and using the system have their own characteristics and preferences which are used to create carrier profiles 220 and shipper profiles 222. The resulting filtered loads 216 are then input into a load recommendation algorithm 218, along with preferences of the carrier and/or the shipper contained within the carrier profiles 220 and shipper profiles 222. The load recommendation algorithm 218 can also score the remaining loads using priorities of the carrier, with the result being that the remaining loads are optimized and scored for the particular carrier doing the search. The scored loads 224 can then be presented to the user. Preferably, these load recommendation scores 224 are ranked according to the scores, such that the user can view the top ranked loads which meet their capabilities, preferences, and/or priorities.

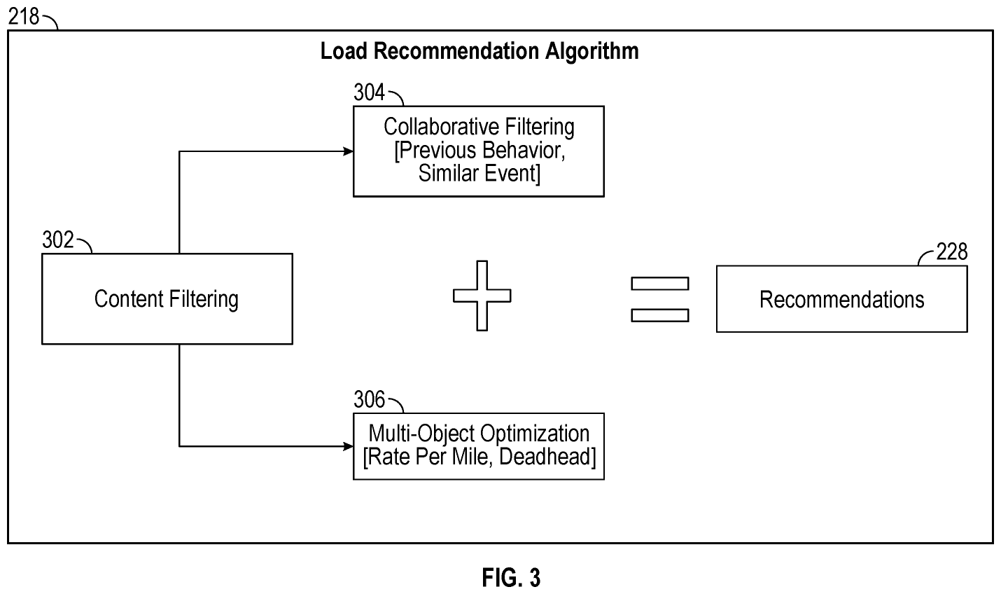

FIG. 3 illustrates an example of the load recommendation algorithm 226. As illustrated, the load recommendation algorithm 226 can perform additional content filtering 302 based on the location, equipment, and date range associated with the input loads. The content filtering 302 will be any additional filtering (if needed) once the three profiles (load, carrier, and shipper) have been put together. The content filtered loads can then be subject to collaborative filtering 304, where previous behavior of the carrier to a similar load, or previous behavior of other similar carriers to a similar load, can be used to evaluate the likelihood that a given load would be appropriate for this carrier. Such determinations can be based on the carrier profile. For example, the carrier profile may indicate certain priorities of the carrier, preferences of the carrier, capabilities of the carrier, etc. Using that carrier profile, the system can identify similar carriers who have experience moving similar loads and, based on those similar carriers, filter out any remaining loads which do not align with the carrier's profile. The load recommendation algorithm 226 can also contain a multi-object optimization 306, which can score the remaining loads based on priorities of the carrier. Exemplary priorities could be the deadhead distance and/or time, the rate per mile in moving a load, etc.

The multi-object optimization 306 can use more than one variable to determine the best load for a given carrier considering multiple available loads (whereas traditional optimization techniques use maximization or minimization of a single variable). The output of a multi object optimization can define the best tradeoff between the competing objectives, with the result that those objectives cannot be directly compared to one another. The result is that the validity of the output of the multi-object optimization 306 is determined by dominance of certain variables over the remaining variables. A solution (x) dominated another solution (y) if:
If x is no worse than y in all objectives; and
Solution x is better than y in at least one objective.
   Based on this a solution associated with load recommendations can be formed by optimizing multiple variables, such as: deadhead, price per mile, total distance to drive, overall rate, and destination.

Consider the following example, where the system is attempting to recommend either Load 1 or Load 2. In example 1: Load 1 has the following characteristics:
Deadhead distance: 105 miles (168.98 km)
Overall rate: $10000
Price per mile: $10/mile ($16/km)
Distance to drive: 1000 miles (1609.34 km)

Load 2 has the following characteristics:
Deadhead distance: 60 miles (95.56 km)
Overall rate: $5000
Price per mile: $20/mile (32/km)
Distance to drive: 250 miles (402.33 km)

In this scenario Load 1 is dominant over Load 2 in terms of overall rate, whereas Load 2 is dominant over Load 1 in rate per mile, distance to drive, and deadhead distance. If the user has identified a given feature (such as deadhead distance) as the most important/dominant feature to be used by the multi-object optimization 306 to make a recommendation, the multi-object optimization 306 can filter according to that user-specified feature. For example, if the user had specified that overall rate should be the dominant feature, then the system would recommend Load 1 over Load 2, whereas if the user had specified that minimizing deadhead distance was the dominant feature than the system would recommend Load 2 over Load 1. In scenarios where there has been no dominant feature specified, or where there is a tie for the dominant feature, the system can select the load which dominants in more categories compared to the other load(s). In this example, because Load 1 only dominates in a single category (overall rate), and Load 2 dominates in the other three categories (deadhead distance, price per mile, and distance to drive), the system would recommend Load 2 over Load 1 if no category were selected as the dominant feature on which recommendations should be made.

In some configurations, the content filtering 302, collaborative filtering 304, and the multi-object optimization 306 can occur sequentially; in other configurations one or more of the content filtering 302, collaborative filtering 304, and the multi-object optimization 306 can occur in parallel. The load recommendation algorithm 226 then generates, using the scores from the multi-object optimization 306 and the results of the content filtering 302 and collaborative filtering 304, recommendations 228, which can be ranked based on the scores. Preferably, the system scores the recommendations with the highest score representing the best load for that particular user, and the lowest score representing the worst load for that particular user. The scoring can use any system known to those of skill in the art, such as (but not limited to) a “0-100” scale, “0-1” scale, or “A-Z” scale.

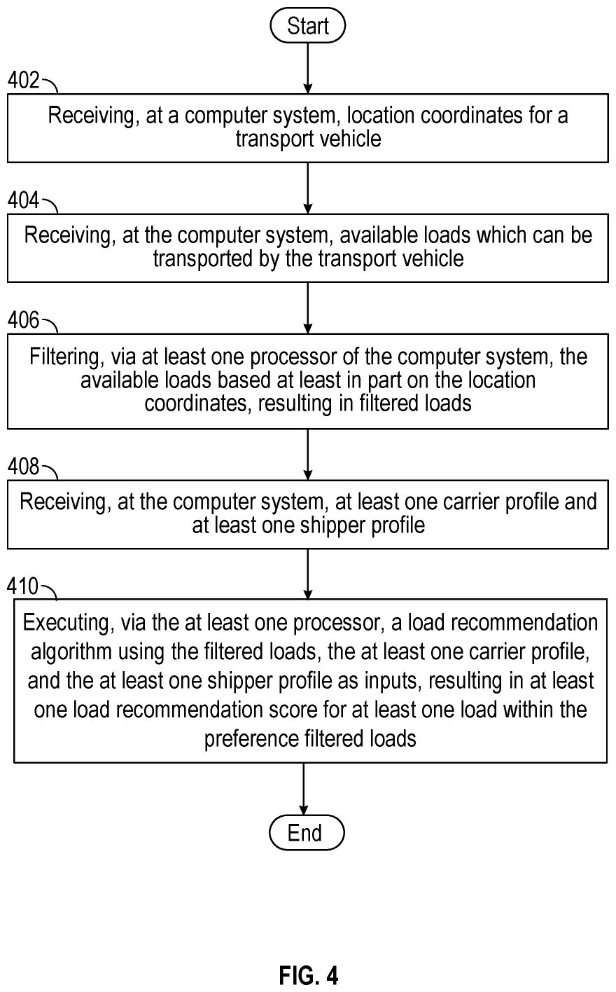

FIG. 4 illustrates an example method embodiment. As illustrated, the method can include receiving, at a computer system, location coordinates for a transport vehicle (402), and receiving, at the computer system, a list of available loads which can be transported by the transport vehicle (404). The method continues by filtering, via at least one processor of the computer system, the list of available loads based at least in part on the location coordinates, resulting in filtered loads (406) and receiving, at the computer system, at least one carrier profile and at least one shipper profile (408). The method then executes, via the at least one processor, a load recommendation algorithm using the filtered loads, the at least one carrier profile, and the at least one shipper profile as inputs, resulting in at least one load recommendation score for at least one load within the preference filtered loads (410).

In some configurations, the illustrated method can further include: calculating, via the at least one processor using the location coordinates and the available loads, a deadhead distance for each of the available loads, resulting in deadhead distances, where the filtering of the available loads is further based on the deadhead distances.

In some configurations, the load recommendation algorithm can further include one or more of: content filtering; collaborative filtering; and multi-object optimization. In such configurations, the collaborative filtering and the multi-object optimization may be executed in parallel or in series, or some combination thereof. For example, in a serially executed system, the collaborative filtering and the multi-object optimization may be executed serially, with the multi-object optimization executed last.

In some configurations, each load within the available loads may include: a pick-up date; a pick-up location; a destination; an origin; and required equipment.

In some configurations, the at least one carrier profile may include: at least one of: a preferred shipper, a preferred lane, and a certification.

In some configurations, the load recommendation algorithm can further include: identifying a carrier preference for a carrier, where the carrier has a carrier profile within the at least one carrier profile; and identifying a shipper preference for a shipper, where the shipper has a shipper profile within the at least one carrier profile, wherein the at least one load recommendation score is based on the carrier preference and the shipper preference.

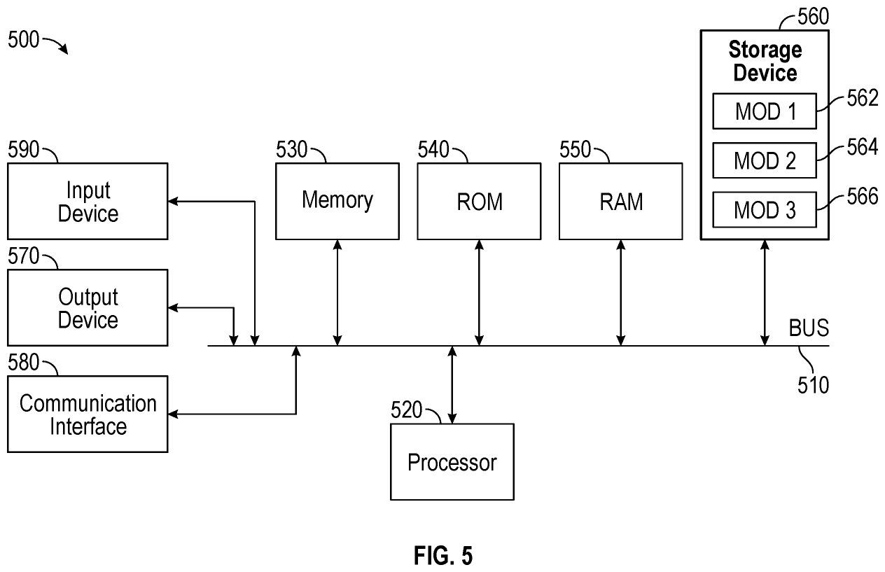

With reference to FIG. 5, an exemplary system includes a general-purpose computing device 500, including a processing unit (CPU or processor) 520 and a system bus 510 that couples various system components including the system memory 530 such as read-only memory (ROM) 540 and random-access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

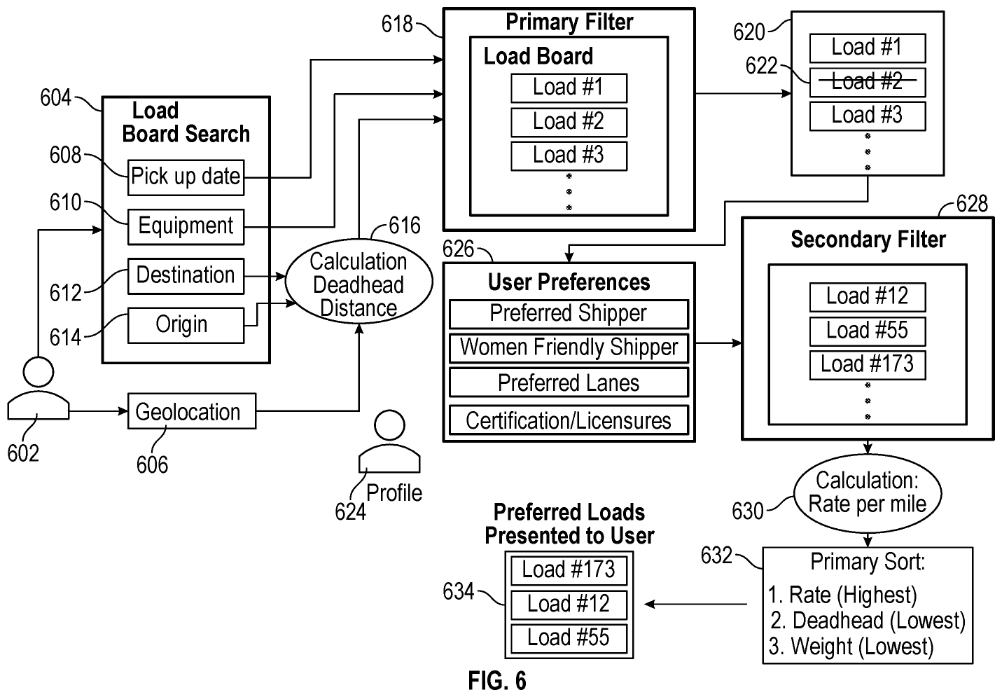

FIG. 6 illustrates an alternative system diagram. As illustrated, a user 602 initiates a search using the system. In this example, the user 602 is acting as a carrier search for loads to transport. The system analyzes a load board 604, where each load has information about the load such as the pick-up date 608, the equipment 610 needed for the load, a destination 612 and an origin 614. The system identifies the geolocation 606 of the user 602 (e.g., the location coordinates of the user's 602 vehicle), then calculates the deadhead distance 616 using the current geolocation 606, the origin 614 of the load, and/or the destination 612 of the load. The system then filters, via a primary filter 618, available loads based on the deadhead distance 616 calculated, the pick-up date 608, the equipment 610, and/or other factors associated with the load and the user 602 capabilities. The filtered available loads 620 can have, as illustrated, one or more loads removed 622 from the available loads which could be accepted by the user 602. For example, as illustrated, Load #2 is removed 622 from the list of available loads.

The system next identifies, using a user profile 624 of the user 602, user preferences 626 of the user 602. Example user preferences 626 can include preferred shippers, women friendly shippers, preferred lanes, certifications/licenses, etc. If the user 602 were instead a shipper, the profile 624 could contain preferences 626 such as preferred carriers, women friendly carriers, preferred lanes, certifications/licenses, etc. Using the preferences 626, the system applies a secondary filter 628 on the initially filtered loads 620, resulting in further filtered loads. For example, as illustrated, the list of available loads now includes Load #12, Load #55, and Load #178.

The system then performs a calculation of a rate/mile 630 for each of the still available loads after the secondary filter 628. These still available loads and the rates associated with each load are then sorted according to the load recommendation algorithm disclosed above, with the result being a sort of the still available loads according to priorities 632 of the user 602. For example, as illustrated, the top priority is the highest rate/mile while the load is being transported, the next highest priority is the lowest amount of deadhead the load would cause, and the third priority is the weight, with a desire for the lowest possible weight. The result of the load recommendation algorithm are the preferred loads 634 of the still available loads, where the preferred loads are ranked based on the priorities 632 of the user 602. The user 602 can then select one or more of the preferred loads and engage in the work of transporting the selected load.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, location coordinates for a transport vehicle; receiving, at the computer system, a list of available loads which can be transported by the transport vehicle; filtering, via at least one processor of the computer system, the list of available loads based at least in part on the location coordinates, resulting in filtered loads; receiving, at the computer system, at least one carrier profile and at least one shipper profile; and executing, via the at least one processor, a load recommendation algorithm using the filtered loads, the at least one carrier profile, and the at least one shipper profile as inputs, resulting in at least one load recommendation score for at least one load within the filtered loads.

The method of any preceding clause, further comprising: calculating, via the at least one processor using the location coordinates and the available loads, a deadhead distance for each of the available loads, resulting in deadhead distances, wherein the filtering of the available loads is further based on the deadhead distances.

The method of any preceding clause, wherein the load recommendation algorithm further comprises: content filtering; collaborative filtering; and multi-object optimization.

The method of any preceding clause, wherein the collaborative filtering and the multi-object optimization are executed in parallel.

The method of any preceding clause, wherein the collaborative filtering and the multi-object optimization are executed serially, with the multi-object optimization executed last.

The method of any preceding clause, wherein each load within the available loads comprises: a pick-up date; a pick-up location; a destination; an origin; and required equipment.

The method of any preceding clause, wherein the at least one carrier profile comprises: at least one of: a preferred shipper, a preferred lane, and a certification.

The method of any preceding clause, wherein the load recommendation algorithm further comprises: identifying a carrier preference for a carrier, where the carrier has a carrier profile within the at least one carrier profile; and identifying a shipper preference for a shipper, where the shipper has a shipper profile within the at least one carrier profile, wherein the at least one load recommendation score is based on the carrier preference and the shipper preference.

A system comprising: at least one processor; and a non-transitory computer-readable storage medium having instructions stored which, when executed by the at least one processor, cause the at least one processor to perform operations comprising: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered loads.

The system of any preceding clause, wherein the non-transitory computer-readable storage medium has additional instructions stored which, when executed by the at least one processor, cause the at least one processor to perform operations comprising: calculating, using the location coordinates and the available loads, a deadhead distance for each of the available loads, resulting in deadhead distances, wherein the filtering of the available loads is further based on the deadhead distances.

The system of any preceding clause, wherein the load recommendation algorithm further comprises: content filtering; collaborative filtering; and multi-object optimization.

The system of any preceding clause, wherein the collaborative filtering and the multi-object optimization are executed in parallel.

The system of any preceding clause, wherein the collaborative filtering and the multi-object optimization are executed serially, with the multi-object optimization executed last.

The system of any preceding clause, wherein each load within the available loads comprises: a pick-up date; a pick-up location; a destination; an origin; and required equipment.

The system of any preceding clause, wherein the at least one carrier profile comprises: at least one of: a preferred shipper, a preferred lane, and a certification.

The system of any preceding clause, wherein the filtering of the load recommendation algorithm further comprises: identifying a carrier preference for a carrier, where the carrier has a carrier profile within the at least one carrier profile; and identifying a shipper preference for a shipper, where the shipper has a shipper profile within the at least one carrier profile, wherein the preferences comprise the carrier preference and the shipper preference.

A non-transitory computer-readable storage medium having instructions stored which, when executed by at least one processor, cause the at least one processor to perform operations comprising: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered loads.

The non-transitory computer-readable storage medium of any preceding clause, having additional instructions stored which, when executed by the at least one processor, cause the at least one processor to perform operations comprising: calculating, using the location coordinates and the available loads, a deadhead distance for each of the available loads, resulting in deadhead distances, wherein the filtering of the available loads is further based on the deadhead distances.

The non-transitory computer-readable storage medium of any preceding clause, wherein the load recommendation algorithm further comprises: content filtering; collaborative filtering; and multi-object optimization.

The non-transitory computer-readable storage medium of any preceding clause, wherein the collaborative filtering and the multi-object optimization are executed in parallel.

A method for load recommendations, comprising: receiving, at a computer system, location coordinates for a transport vehicle; receiving, at the computer system, a list of available loads which can be transported by the transport vehicle; filtering, via at least one processor of the computer system, the list of available loads based at least in part on the location coordinates, resulting in filtered loads; receiving, at the computer system, at least one carrier profile and at least one shipper profile; and executing, via the at least one processor, a load recommendation algorithm using the filtered loads, the at least one carrier profile, and the at least one shipper profile as inputs, resulting in at least one load recommendation score for at least one load within the filtered loads.

The method of any preceding clause, further comprising: calculating, via the at least one processor using the location coordinates and the available loads, a deadhead distance for each of the available loads, resulting in deadhead distances, wherein the filtering of the available loads is further based on the deadhead distances.

The method of any preceding clause, wherein the load recommendation algorithm further comprises: content filtering; collaborative filtering; and multi-object optimization.

The method of any preceding clause, wherein the collaborative filtering and the multi-object optimization are executed in parallel.

The method of any preceding clause, wherein the collaborative filtering and the multi-object optimization are executed serially, with the multi-object optimization executed last.

The method of any preceding clause, wherein each load within the available loads comprises: a pick-up date; a pick-up location; a destination; an origin; and required equipment.

The method of any preceding clause, wherein the at least one carrier profile comprises: at least one of: a preferred shipper, a preferred lane, and a certification.

The method of any preceding clause, wherein the load recommendation algorithm further comprises: identifying a carrier preference for a carrier, where the carrier has a carrier profile within the at least one carrier profile; and identifying a shipper preference for a shipper, where the shipper has a shipper profile within the at least one carrier profile, wherein the at least one load recommendation score is based on the carrier preference and the shipper preference.

A system for load recommendations, comprising: at least one processor; and a non-transitory computer-readable storage medium configured to, with the at least one processor, cause the system to perform operations comprising: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered load.

The system of any preceding clause, wherein the non-transitory computer-readable storage medium is further configured to, with the at least one processor, cause the system to perform operations comprising: calculating, using the location coordinates and the available loads, a deadhead distance for each of the available loads, resulting in deadhead distances, wherein the filtering of the available loads is further based on the deadhead distances.

The system of any preceding clause, wherein the load recommendation algorithm further comprises: content filtering; collaborative filtering; and multi-object optimization.

The system of any preceding clause, wherein the collaborative filtering and the multi-object optimization are executed in parallel.

The system of any preceding clause, wherein the collaborative filtering and the multi-object optimization are executed serially, with the multi-object optimization executed last.

The system of any preceding clause, wherein each load within the available loads comprises: a pick-up date; a pick-up location; a destination; an origin; and required equipment.

The system of any preceding clause, wherein the at least one carrier profile comprises: at least one of: a preferred shipper, a preferred lane, and a certification.

The system of any preceding clause, wherein the filtering of the load recommendation algorithm further comprises: identifying a carrier preference for a carrier, where the carrier has a carrier profile within the at least one carrier profile; and identifying a shipper preference for a shipper, where the shipper has a shipper profile within the at least one carrier profile, wherein the preferences comprise the carrier preference and the shipper preference.

A non-transitory computer-readable storage medium that stores a method for load recommendations, the method comprising: receiving location coordinates for a transport vehicle; receiving available loads which can be transported by the transport vehicle; filtering the available loads based at least in part on the location coordinates, resulting in filtered loads; receiving at least one carrier profile and at least one shipper profile; and executing a load recommendation algorithm using the filtered loads, the at least one carrier profile, and the at least one shipper profile as inputs, resulting in at least one load recommendation score for at least one load within the filtered loads.

The non-transitory computer-readable storage medium of any preceding clause, wherein the method stored therein further comprises: calculating, using the location coordinates and the available loads, a deadhead distance for each of the available loads, resulting in deadhead distances, wherein the filtering of the available loads is further based on the deadhead distances.

The non-transitory computer-readable storage medium of any preceding clause, wherein the load recommendation algorithm further comprises: content filtering; collaborative filtering; and multi-object optimization.

The non-transitory computer-readable storage medium of any preceding clause, wherein the collaborative filtering and the multi-object optimization are executed in parallel.

We claim:

1. A method comprising:
receiving, at a computer system, location coordinates for a transport vehicle;
receiving, at the computer system, a list of available loads which can be transported by the transport vehicle;
filtering, via at least one processor of the computer system, the list of available loads based at least in part on the location coordinates, resulting in filtered loads;
receiving, at the computer system, at least one carrier profile and at least one shipper profile; and
executing, via the at least one processor, a load recommendation algorithm using the filtered loads, the at least one carrier profile, and the at least one shipper profile as inputs, resulting in at least one load recommendation score for at least one load within the filtered loads.

2. The method of claim 1, further comprising:
calculating, via the at least one processor using the location coordinates and the available loads, a deadhead distance for each of the available loads, resulting in deadhead distances,
wherein the filtering of the available loads is further based on the deadhead distances.

3. The method of claim 1, wherein the load recommendation algorithm further comprises:
content filtering;
collaborative filtering; and
multi-object optimization.

4. The method of claim 3, wherein the collaborative filtering and the multi-object optimization are executed in parallel.

5. The method of claim 3, wherein the collaborative filtering and the multi-object optimization are executed serially, with the multi-object optimization executed last.

6. The method of claim 1, wherein each load within the available loads comprises:
a pick-up date;
a pick-up location;
a destination;
an origin; and
required equipment.

7. The method of claim 1, wherein the at least one carrier profile comprises:
at least one of: a preferred shipper, a preferred lane, and a certification.

8. The method of claim 1, wherein the load recommendation algorithm further comprises:
identifying a carrier preference for a carrier, where the carrier has a carrier profile within the at least one carrier profile; and
identifying a shipper preference for a shipper, where the shipper has a shipper profile within the at least one carrier profile,
wherein the at least one load recommendation score is based on the carrier preference and the shipper preference.

9. A system comprising:
at least one processor; and
a non-transitory computer-readable storage medium having instructions stored which, when executed by the at least one processor, cause the at least one processor to perform operations comprising:
receiving location coordinates for a transport vehicle;
receiving available loads which can be transported by the transport vehicle;
filtering the available loads based at least in part on the location coordinates, resulting in filtered loads;
receiving at least one carrier profile and at least one shipper profile; and
executing a load recommendation algorithm using the filtered loads, the at least one carrier profile, and the at least one shipper profile as inputs, resulting in at least one load recommendation score for at least one load within the filtered loads.

10. The system of claim 9, wherein the non-transitory computer-readable storage medium has additional instructions stored which, when executed by the at least one processor, cause the at least one processor to perform operations comprising:
calculating, using the location coordinates and the available loads, a deadhead distance for each of the available loads, resulting in deadhead distances,
wherein the filtering of the available loads is further based on the deadhead distances.

11. The system of claim 9, wherein the load recommendation algorithm further comprises:
content filtering;
collaborative filtering; and
multi-object optimization.

12. The system of claim 11, wherein the collaborative filtering and the multi-object optimization are executed in parallel.

13. The system of claim 11, wherein the collaborative filtering and the multi-object optimization are executed serially, with the multi-object optimization executed last.

14. The system of claim 9, wherein each load within the available loads comprises:
a pick-up date;
a pick-up location;
a destination;
an origin; and
required equipment.

15. The system of claim 9, wherein the at least one carrier profile comprises:
at least one of: a preferred shipper, a preferred lane, and a certification.

16. The system of claim 9, wherein the filtering of the load recommendation algorithm further comprises:
identifying a carrier preference for a carrier, where the carrier has a carrier profile within the at least one carrier profile; and
identifying a shipper preference for a shipper, where the shipper has a shipper profile within the at least one carrier profile,
wherein the preferences comprise the carrier preference and the shipper preference.

17. A non-transitory computer-readable storage medium having instructions stored which, when executed by at least one processor, cause the at least one processor to perform operations comprising:
receiving location coordinates for a transport vehicle;
receiving available loads which can be transported by the transport vehicle;
filtering the available loads based at least in part on the location coordinates, resulting in filtered loads;
receiving at least one carrier profile and at least one shipper profile; and
executing a load recommendation algorithm using the filtered loads, the at least one carrier profile, and the at least one shipper profile as inputs, resulting in at least one load recommendation score for at least one load within the filtered loads.

18. The non-transitory computer-readable storage medium of claim 17, having additional instructions stored which, when executed by the at least one processor, cause the at least one processor to perform operations comprising:
calculating, using the location coordinates and the available loads, a deadhead distance for each of the available loads, resulting in deadhead distances,
wherein the filtering of the available loads is further based on the deadhead distances.

19. The non-transitory computer-readable storage medium of claim 17, wherein the load recommendation algorithm further comprises:
content filtering;
collaborative filtering; and
multi-object optimization.

20. The non-transitory computer-readable storage medium of claim 19, wherein the collaborative filtering and the multi-object optimization are executed in parallel.
